(19) United States
(12) Patent Application Publication
(10) Pub. No.: US 2025/0215314 A1
(43) Pub. Date: Jul. 3, 2025

(54) PRECURSOR MATERIAL FOR SYNTHESIS OF GROUP III-V QUANTUM DOTS AND PREPARATION METHOD THEREFOR

(71) Applicant: RESEARCH & BUSINESS FOUNDATION SUNGKYUNKWAN UNIVERSITY, Suwon-si (KR)

(72) Inventors: Sohee JEONG, Suwon-si (KR); Hyoin KIM, Suwon-si (KR); Taewan KIM, Suwon-si (KR); Mahnmin CHOI, Suwon-si (KR); Meeree KIM, Suwon-si (KR); Eunhye CHO, Suwon-si (KR); Seongmin PARK, Suwon-si (KR); Jibin SHIN, Suwon-si (KR)

(21) Appl. No.: 19/087,773

(22) Filed: Mar. 24, 2025

Related U.S. Application Data
(63) Continuation of application No. PCT/KR2023/015906, filed on Oct. 16, 2023.

(30) Foreign Application Priority Data
Oct. 14, 2022 (KR) 10-2022-0132316

(51) Int. Cl. C09K 11/74; B82Y 20/00; B82Y 40/00; C01G 28/00

(52) U.S. Cl. CPC C09K 11/7492; C01G 28/00; B82Y 20/00; B82Y 40/00; C01P 2002/72

(57) ABSTRACT

The present application relates to a precursor material for the synthesis of Group III-V quantum dots, including a Group II-V cluster compound having amorphous characteristics.

### TECHNICAL FIELD

The present disclosure relates to a precursor material for synthesis of Group III-V quantum dots and a preparation method therefor.

### BACKGROUND ART

Quantum dots are semiconductor nanocrystals that exhibit quantum confinement effects, which have unique electrical and optical characteristics that are different from electrical and optical characteristics of bulk materials according to a size of the nanocrystal. Due to such characteristics, the quantum dots are being actively studied as materials to be applied to various optoelectronic devices. Among the quantum dots, indium arsenide (InAs) quantum dots are materials capable of absorbing and emitting light in near-infrared (NIR) and short-wave infrared (SWIR) regions, and are attracting attention as materials to replace existing Cd- and Pb-based infrared quantum dots that are restricted in various commercial uses due to their strong toxicity.

Despite such demands, types of arsenic precursors used in synthesis of the InAs quantum dots are not diverse, and tris(trimethylsilyl)arsenide (TMS₃As) and tris(dimethylamino)arsine (DMA₃As) are mainly used. In the case of TMS₃As, although TMS₃As has been studied the most in order to obtain quantum dots having a uniform size, there are risks of ignition and generation of toxic AsH₃ gas upon contact with air and moisture, and there is a limitation that TMS₃As is an ultra-expensive precursor. In the case of DMA₃As, although DMA₃As has an advantage of being relatively stable, an additional reducing agent for reducing arsenic having an oxidation number of +3 to arsenic having an oxidation number of −3 is required in order to form InAs upon reaction with InCl₃. In this case, in order to obtain quantum dots having a uniform size, reducing power and a reaction temperature have to be adjusted within appropriate ranges, and there is a limitation that reaction in inappropriate ranges may cause large size distribution of the quantum dots, formation of indium metals and oxides, or failure to obtain desired reaction.

In addition to a scheme of directly reacting a precursor in a molecular form, it has been reported that a cluster may be used for synthesis and growth of quantum dots. In particular, it has been reported that growth of the InAs quantum dots may be controlled by using a cluster having appropriate reactivity as compared to the precursor in the molecular form. However, this is still limited to Group III-V clusters, so that there is a limitation in use of a cluster as a precursor for growth control.

Therefore, there is a need for development of cluster precursors based on other group metal precursors other than the Group III-V clusters including Group III precursors and Group V precursors.

Korean Unexamined Patent Publication No. 10-2020-0033563 relates to a quantum dot precursor. The patent discloses a quantum dot precursor including a Zn precursor, capable of having excellent solubility even when a solvent having a high boiling point is used while maintaining high optical characteristics so that the quantum dot precursor may be uniformly maintained without precipitating an unreacted precursor even at low temperatures, thereby purifying quantum dots with a high yield, but does not disclose a precursor in a cluster form.

### DISCLOSURE

### Technical Problem

To solve the problems of the related art described above, an object of the present disclosure is to provide a precursor for synthesis of Group III-V quantum dots, which includes a Group II-V cluster including a Group I precursor and a Group V precursor.

In addition, an object of the present disclosure is to provide a preparation method for the precursor for the synthesis of the Group III-V quantum dots.

In addition, an object of the present disclosure is to provide a preparation method for Group III-V quantum dots by using the precursor for the synthesis of the Group III-V quantum dots.

In addition, an object of the present disclosure is to provide a Group III-V quantum dot prepared through the preparation method for the Group III-V quantum dots.

However, technical objects to be achieved by an embodiment of the present disclosure are not limited to the technical objects described above, and other technical objects may exist.

### Technical Solution

As technical solutions for achieving the technical objects described above, a first aspect of the present disclosure provides a precursor for synthesis of Group III-V quantum dots, the precursor including: a Group I-V cluster compound having amorphous characteristics.

According to one embodiment of the present disclosure, a Group II element of the Group II-V cluster compound may be selected from the group consisting of Zn, Cd, Hg, and combinations thereof, but is not limited thereto.

According to one embodiment of the present disclosure, a Group V element of the Group II-V cluster compound may be selected from the group consisting of As, N, P, Sb and combinations thereof, but is not limited thereto.

According to one embodiment of the present disclosure, the Group II-V cluster compound may include a composition of Zn₃As₂, Zn₃As, Cd₃As₂, or Cd₃P₂, but is not limited thereto.

According to one embodiment of the present disclosure, the Group III-V quantum dot may be selected from the group consisting of InAs, InP, In₁₋ₓGaₓP_{1-y}As_{y} (where each of x and y is greater than 0 and less than 1), In₁₋ₓZnₓP_{1-y}As_{y} (where each of x and y is greater than 0 and less than 1), In₁₋ₓCdₓP_{1-y}As_{y} (where each of x and y is greater than 0 and less than 1), and combinations thereof, but is not limited thereto.

In addition, a second aspect of the present disclosure provides a preparation method for a precursor for synthesis of Group III-V quantum dots, the preparation method including: preparing a first mixture solution by mixing a Group II precursor, a Group V precursor, and a first solvent; and preparing a Group I-V cluster compound by heating the first mixture solution.

According to one embodiment of the present disclosure, in the preparing of the Group II-V cluster compound, formation of the Group I-V cluster compound may be adjusted by controlling a heating temperature and/or a heating time, but is not limited thereto.

According to one embodiment of the present disclosure, the Group II precursor may be selected from the group consisting of diethyl zinc, zinc oleate, zinc acetate, dimethyl zinc, zinc carboxylate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, dimethyl cadmium, diethyl cadmium, cadmium oxide, cadmium carbonate, cadmium acetate dihydrate, cadmium acetylacetonate, cadmium fluoride, cadmium chloride, cadmium iodide, cadmium bromide, cadmium perchlorate, cadmium phosphide, cadmium nitrate, cadmium sulfate, cadmium carboxylate, mercury iodide, mercury bromide, mercury fluoride, mercury cyanide, mercury nitrate, mercury perchlorate, mercury sulfate, mercury oxide, mercury carbonate, mercury carboxylate, and combinations thereof, but is not limited thereto.

According to one embodiment of the present disclosure, the Group V precursor may be selected from the group consisting of tris(dimethylamino)arsine (DMA₃As), arsenic oxide, arsenic chloride, arsenic sulfate, arsenic bromide, arsenic iodide, tris(trimethylsilyl)arsenide (TMS₃As), arsenic trioxide, arsenic silylamide, alkyl phosphine, tris(trialkylsilyl)phosphine, tris(dialkylsilyl)phosphine, tris(dialkylamino)phosphine, nitric oxide, nitric acid, ammonium nitrate, and combinations thereof, but is not limited thereto.

According to one embodiment of the present disclosure, the first solvent may be selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof, but is not limited thereto.

In addition, a third aspect of the present disclosure provides a preparation method for a precursor for synthesis of Group IH-V quantum dots, the preparation method including: heating a solution in which a first precursor and a first solvent are mixed; and preparing a Group H-V cluster compound by adding a second precursor while maintaining a heating temperature of the solution, wherein the first precursor and the second precursor are each independently a Group H precursor or a Group V precursor, and the first precursor and the second precursor are different from each other.

According to one embodiment of the present disclosure, the Group II precursor may be selected from the group consisting of diethyl zinc, zinc oleate, zinc acetate, dimethyl zinc, zinc carboxylate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, dimethyl cadmium, diethyl cadmium, cadmium oxide, cadmium carbonate, cadmium acetate dihydrate, cadmium acetylacetonate, cadmium fluoride, cadmium chloride, cadmium iodide, cadmium bromide, cadmium perchlorate, cadmium phosphide, cadmium nitrate, cadmium sulfate, cadmium carboxylate, mercury iodide, mercury bromide, mercury fluoride, mercury cyanide, mercury nitrate, mercury perchlorate, mercury sulfate, mercury oxide, mercury carbonate, mercury carboxylate, and combinations thereof, but is not limited thereto.

According to one embodiment of the present disclosure, the Group V precursor may be selected from the group consisting of tris(dimethylamino)arsine (DMA₃As), arsenic oxide, arsenic chloride, arsenic sulfate, arsenic bromide, arsenic iodide, tris(trimethylsilyl)arsenide (TMS₃As), arsenic trioxide, arsenic silylamide, alkyl phosphine, tris(trialkylsilyl)phosphine, tris(dialkylsilyl)phosphine, tris(dialkylamino)phosphine, nitric oxide, nitric acid, ammonium nitrate, and combinations thereof, but is not limited thereto.

According to one embodiment of the present disclosure, the first solvent may be selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof, but is not limited thereto.

In addition, a fourth aspect of the present disclosure provides a preparation method for Group III-V quantum dots, the preparation method including: preparing a second mixture solution by mixing a precursor for synthesis of Group III-V quantum dots according to the first aspect of the present disclosure, a Group III precursor, and a second solvent; and heating the second mixture solution.

According to one embodiment of the present disclosure, in the heating, a size of the prepared quantum dot may be gradually increased as a heating temperature increases, but is not limited thereto.

According to one embodiment of the present disclosure, in the heating, the heating may be performed while additionally injecting the second mixture solution, but is not limited thereto.

According to one embodiment of the present disclosure, the Group III precursor may be selected from the group consisting of indium chloride, indium iodide, indium chloride tetrahydrate, indium oxide, indium nitrate, indium nitrate hydrate, indium sulfate, indium sulfate hydrate, indium acetate, indium acetylacetonate, indium bromide, indium fluoride, indium fluoride trihydrate, trimethyl indium, indium oleate, indium carboxylate, aluminum acetate, aluminum iodide, aluminum bromide, aluminum chloride, aluminum chloride hexahydrate, aluminum fluoride, aluminum nitrate, aluminum oxide, aluminum perchlorate, aluminum carbide, aluminum stearate, aluminum sulfate, di-i-butylaluminum chloride, diethylaluminum chloride, tri-i-butylaluminum, triethylaluminum, triethyl(tri-sec-butoxy)dialuminum, aluminum phosphate, aluminum acetylacetonate, trimethylaluminum, gallium acetylacetonate, gallium chloride, gallium fluoride, gallium fluoride trihydrate, gallium oxide, gallium nitrate, gallium nitrate hydrate, gallium sulfate, gallium iodide, triethyl gallium, trimethyl gallium, and combinations thereof, but is not limited thereto.

According to one embodiment of the present disclosure, the second solvent may be selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof, but is not limited thereto.

In addition, a fifth aspect of the present disclosure provides a Group III-V quantum dot prepared by a preparation method according to the fourth aspect of the present disclosure.

In addition, a sixth aspect of the present disclosure provides a preparation method for Group III-V quantum dots, the preparation method including: heating a solution including a Group III precursor and a second solvent; and adding a precursor for synthesis of Group III-V quantum dots according to the first aspect of the present disclosure while maintaining a heating temperature of the solution.

According to one embodiment of the present disclosure, in the heating, a size of the prepared quantum dot may be gradually increased as a heating temperature increases, but is not limited thereto.

According to one embodiment of the present disclosure, the Group III precursor may be selected from the group consisting of indium chloride, indium iodide, indium chloride tetrahydrate, indium oxide, indium nitrate, indium nitrate hydrate, indium sulfate, indium sulfate hydrate, indium acetate, indium acetylacetonate, indium bromide, indium fluoride, indium fluoride trihydrate, trimethyl indium, indium oleate, indium carboxylate, aluminum acetate, aluminum iodide, aluminum bromide, aluminum chloride, aluminum chloride hexahydrate, aluminum fluoride, aluminum nitrate, aluminum oxide, aluminum perchlorate, aluminum carbide, aluminum stearate, aluminum sulfate, di-i-butylaluminum chloride, diethylaluminum chloride, tri-i-butylaluminum, triethylaluminum, triethyl(tri-sec-butoxy)dialuminum, aluminum phosphate, aluminum acetylacetonate, trimethylaluminum, gallium acetylacetonate, gallium chloride, gallium fluoride, gallium fluoride trihydrate, gallium oxide, gallium nitrate, gallium nitrate hydrate, gallium sulfate, gallium iodide, triethyl gallium, trimethyl gallium, and combinations thereof, but is not limited thereto.

According to one embodiment of the present disclosure, the second solvent may be selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof, but is not limited thereto.

The above-described solutions for achieving the objects are provided merely for illustrative purposes, and are not to be construed as being intended to limit the present disclosure. In addition to exemplary embodiments described above, additional embodiments may exist in the drawings and the detailed description of the invention.

### Advantageous Effects

A precursor for synthesis of Group III-V quantum dots according to the present disclosure may include a Group II-V cluster compound having amorphous characteristics, and can serve as a source of a Group V element having appropriate reactivity in forming the Group III-V quantum dots.

In addition, although a cluster including a Group III precursor and a Group V precursor has been used to attempt growth control of Group III-V quantum dots according the related art, a quantum dot material containing other group metals, such as Group III-V quantum dots doped with a Group II element and Group III-V quantum dots passivated with a Group II element, can be implemented by synthesizing a cluster based on other group metal precursors and using the cluster as a precursor.

In addition, since the Group II-V cluster compound may be formed through heating without being formed at a room temperature, formation reaction of the Group II-V cluster compound can be controlled, and the Group II-V cluster compound can be easily stored at a room temperature or less.

In addition, an additional reducing agent may be unnecessary in mixing and reaction processes with a Group III precursor, and Group III-V quantum dots can be formed through various process methods in a wide temperature range by excluding addition of a reducing agent having high reactivity in a synthesis process of the Group III-V quantum dots.

However, effects that may be obtained in the present disclosure are not limited to the effects described above, and other effects may exist.

### DESCRIPTION OF DRAWINGS

FIG. 1 is a flowchart showing a preparation method for a precursor for synthesis of Group III-V quantum dots according to one embodiment of the present disclosure.

FIG. 2 is a schematic view showing the preparation method for the precursor for the synthesis of the Group III-V quantum dots according to one embodiment of the present disclosure.

FIG. 3 is a flowchart showing a preparation method for Group III-V quantum dots according to one embodiment of the present disclosure.

FIG. 4 is a schematic view showing the preparation method for the Group III-V quantum dots according to one embodiment of the present disclosure.

FIG. 5 is an absorbance spectrum and an image showing states before and after heating of a mixture solution for preparing a Group II-V cluster compound according to one example of the present disclosure.

FIG. 6 is an XRD pattern showing the Group II-V cluster compound prepared according to one example of the present disclosure.

FIG. 7 is an absorbance spectrum showing InAs quantum dots prepared according to one example of the present disclosure.

FIG. 8 is an XRD pattern showing the InAs quantum dots prepared according to one example of the present disclosure.

FIG. 9 is an absorbance spectrum showing Group II-V cluster compounds prepared according to Examples 5-1 to 5-5 of the present disclosure.

FIG. 10 is an absorbance spectrum showing Group II-V cluster compounds prepared according to Examples 6-1 to 6-10 of the present disclosure.

FIG. 11 is an absorbance spectrum showing Group II-V cluster compounds prepared according to Examples 7-1 to 7-10 of the present disclosure.

### MODE FOR INVENTION

Hereinafter, an embodiment of the present disclosure will be described in detail with reference to the accompanying drawings so as to be easily practiced by a person having ordinary skill in the art to which the present disclosure pertains.

However, the present disclosure may be implemented in various different forms without being limited to the embodiment described herein. In addition, in order to clearly describe the present disclosure, in the drawings, parts that are not related to the description are omitted, and like parts are given like reference numerals throughout the present disclosure.

Throughout the present disclosure, when some part is described as being “connected” to another part, this includes not only a case where the part is “directly connected” to the other part, but also a case where the part is “electrically connected” to the other part with another device interposed therebetween.

Throughout the present disclosure, when some member is described as being located “on”, “over”, “above”, “under”, “below”, or “beneath” another member, this includes not only a case where the member makes contact with the other member, but also a case where another member exists between the two members.

Throughout the present disclosure, when some part is described as “including” some component, unless explicitly described to the contrary, it means that another component may be further included but not excluded.

The terms that express degrees, such as “about” and “substantially”, used in the present disclosure have meanings that are at a numerical value or close to the numerical value when unique manufacturing and material tolerances are presented in a stated meaning, and are used to prevent unconscientious infringers from unfairly exploiting the disclosure in which an exact or absolute value is stated in order to help understanding of the present disclosure. In addition, throughout the present disclosure, “step that . . . ” or “step of . . . ” do not mean “step for . . . ”.

Throughout the present disclosure, the term “combinations thereof” included in an expression in the Markush form means at least one mixture or combination selected from the group consisting of components described in the expression in the Markush form, and means inclusion of at least one selected from the group consisting of the components.

Throughout the present disclosure, the expression “A and/or B” means “A or B, or A and B.”

Hereinafter, a precursor for synthesis of Group III-V quantum dots and a preparation method therefor will be described in detail with reference to embodiments and examples as well as the drawings. However, the present disclosure is not limited to the embodiments, the examples, and the drawings.

As technical solutions for achieving the technical objects described above, a first aspect of the present disclosure provides a precursor for synthesis of Group I-V quantum dots, the precursor including: a Group I-V cluster compound having amorphous characteristics.

A precursor for synthesis of Group II-V quantum dots according to the present disclosure may include a Group I-V cluster compound, and the Group I-V cluster compound may serve as a source of a Group V element having appropriate reactivity in forming the Group III-V quantum dots.

A cluster compound may refer to a non-crystalline compound having an ensemble of various atoms having nanometer (nm)-scale sizes, which is formed by a direct bond between constituent elements or a bond through a ligand. Although a cluster including a Group f precursor and a Group V precursor has been used to attempt growth control of Group III-V quantum dots according the related art, according to a precursor for synthesis of Group II-V quantum dots of the present disclosure, a quantum dot material containing other group metals, such as Group III-V quantum dots doped with a Group II element and Group III-V quantum dots passivated with a Group II element, may be implemented by synthesizing a cluster based on other group metal precursors (a Group I-V cluster compound) and using the cluster as a precursor.

In addition, since the Group II-V cluster compound may be formed through heating without being formed at a room temperature, formation reaction of the Group II-V cluster compound may be controlled, and the Group II-V cluster compound may be easily stored at a room temperature or less.

In addition, an additional reducing agent may be unnecessary in mixing and reaction processes with a Group III precursor, and Group III-V quantum dots may be formed through various process methods in a wide temperature range by excluding addition of a reducing agent having high reactivity in a synthesis process of the Group III-V quantum dots.

In addition, the Group II-V cluster compound may have amorphous characteristics upon XRD analysis. According to the present disclosure, the amorphous characteristics may be defined as showing a featureless spectrum upon XRD spectrum analysis. In other words, the Group II-V cluster compound having the amorphous characteristics may be a non-crystalline cluster, or a specific peak may not be found upon XRD analysis due to a small size.

In a case of a cluster having amorphous characteristics, the cluster may be decomposed under predetermined reaction conditions (e.g., a temperature and a concentration) to provide a monomer in a quantum dot synthesis process. Meanwhile, when a precursor has an excessively large size or has crystallinity (a crystalline nanocrystal), the precursor may not be easily decomposed, so that there may be a limitation in smoothly supplying a monomer in the quantum dot synthesis process. Accordingly, in the quantum dot synthesis process, nucleus generation and control of a growth speed of quantum dots may not be easily performed, so that high-quality quantum dots may not be generated. However, as described above, the Group II-V cluster compound according to an embodiment of the present disclosure may have amorphous or non-crystalline characteristics, so that the Group II-V cluster compound may be decomposed according to a temperature and a concentration in the quantum dot synthesis process so as to easily supply a monomer required for the quantum dot synthesis process. As a result, high-quality quantum dots may be prepared in large quantities.

According to one embodiment of the present disclosure, a Group II element of the Group II-V cluster compound may be selected from the group consisting of Zn, Cd, Hg, and combinations thereof, but is not limited thereto.

According to one embodiment of the present disclosure, a Group V element of the Group II-V cluster compound may be selected from the group consisting of As, N, P, Sb and combinations thereof, but is not limited thereto.

According to one embodiment of the present disclosure, the Group II-V cluster compound may include a composition of Zn₃As₂, Zn₃As, Cd₃As₂, or Cd₃P₂, but is not limited thereto.

According to one embodiment of the present disclosure, the Group III-V quantum dot may be selected from the group consisting of InAs, InP, In₁₋ₓGaₓP_{1-y}As_{y} (where each of x and y is greater than 0 and less than 1), In₁₋ₓZnₓP_{1-y}As_{y} (where each of x and y is greater than 0 and less than 1), In₁₋ₓCdₓP_{1-y}As_{y} (where each of x and y is greater than 0 and less than 1), and combinations thereof, but is not limited thereto.

In addition, a second aspect of the present disclosure provides a preparation method for a precursor for synthesis of Group III-V quantum dots, the preparation method including: preparing a first mixture solution by mixing a Group II precursor, a Group V precursor, and a first solvent; and preparing a Group II-V cluster compound by heating the first mixture solution.

Regarding the preparation method for the precursor for the synthesis of the Group III-V quantum dots according to the second aspect of the present disclosure, detailed descriptions of parts overlapping the first aspect of the present disclosure have been omitted. However, even though the descriptions are omitted, the contents described in the first aspect of the present disclosure may be equally applied to the second aspect of the present disclosure.

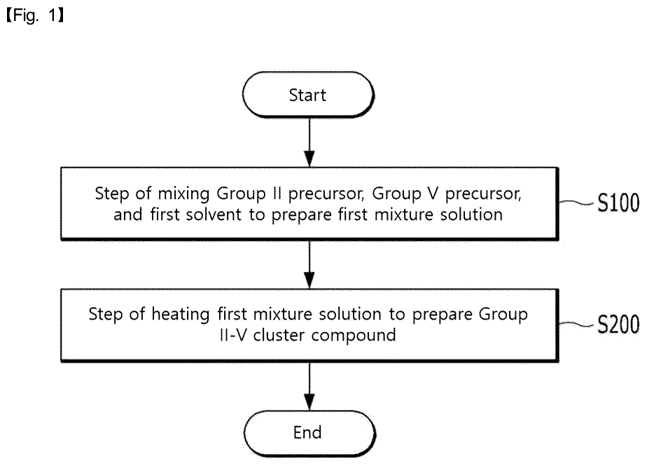

FIG. 1 is a flowchart showing a preparation method for a precursor for synthesis of Group III-V quantum dots according to one embodiment of the present disclosure.

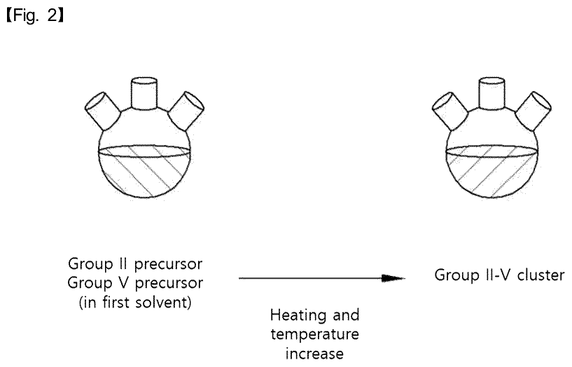

FIG. 2 is a schematic view showing the preparation method for the precursor for the synthesis of the Group III-V quantum dots according to one embodiment of the present disclosure.

First, a first mixture solution may be prepared by mixing a Group II precursor, a Group V precursor, and a first solvent (S100).

According to one embodiment of the present disclosure, the Group II precursor may be selected from the group consisting of diethyl zinc, zinc oleate, zinc acetate, dimethyl zinc, zinc carboxylate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, dimethyl cadmium, diethyl cadmium, cadmium oxide, cadmium carbonate, cadmium acetate dihydrate, cadmium acetylacetonate, cadmium fluoride, cadmium chloride, cadmium iodide, cadmium bromide, cadmium perchlorate, cadmium phosphide, cadmium nitrate, cadmium sulfate, cadmium carboxylate, mercury iodide, mercury bromide, mercury fluoride, mercury cyanide, mercury nitrate, mercury perchlorate, mercury sulfate, mercury oxide, mercury carbonate, mercury carboxylate, and combinations thereof, but is not limited thereto.

According to one embodiment of the present disclosure, the Group V precursor may be selected from the group consisting of tris(dimethylamino)arsine (DMA₃As), arsenic oxide, arsenic chloride, arsenic sulfate, arsenic bromide, arsenic iodide, tris(trimethylsilyl)arsenide (TMS₃As), arsenic trioxide, arsenic silylamide, alkyl phosphine, tris(trialkylsilyl)phosphine, tris(dialkylsilyl)phosphine, tris(dialkylamino)phosphine, nitric oxide, nitric acid, ammonium nitrate, and combinations thereof, but is not limited thereto.

According to one embodiment of the present disclosure, the first solvent may be selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof, but is not limited thereto.

Next, a Group H-V cluster compound may be prepared by heating the first mixture solution (S200).

Since the Group H-V cluster compound may be formed through the heating without being formed at a room temperature, formation reaction of the Group II-V cluster compound may be controlled, and the Group II-V cluster compound may be easily stored at a room temperature or less.

According to one embodiment of the present disclosure, in the preparing of the Group H-V cluster compound, formation of the Group II-V cluster compound may be adjusted by controlling a heating temperature and/or a heating time, but is not limited thereto.

In detail, the heating temperature may vary according to reactivity of the Group H precursor and the Group V precursor, which are precursors for synthesizing the Group II-V cluster compound. For example, diethyl zinc and DMA₃As may form a cluster at a heating temperature of 160° C. or more, and zinc acetate and TMS₃As may form a cluster at a heating temperature of 100° C. or more. Therefore, the preparation of the cluster compound may be adjusted by controlling the heating temperature according to a type of a reactant for synthesizing the Group II-V cluster compound. In addition, the cluster may gradually grow as the heating time increases, so that formation of the cluster compound may be adjusted by controlling the heating time.

In addition, a third aspect of the present disclosure provides a preparation method for a precursor for synthesis of Group III-V quantum dots, the preparation method including: heating a solution in which a first precursor and a first solvent are mixed; and preparing a Group II-V cluster compound by adding a second precursor while maintaining a heating temperature of the solution, wherein the first precursor and the second precursor are each independently a Group II precursor or a Group V precursor, and the first precursor and the second precursor are different from each other.

Regarding the preparation method for the precursor for the synthesis of the Group III-V quantum dots according to the third aspect of the present disclosure, detailed descriptions of parts overlapping the first aspect of the present disclosure have been omitted. However, even though the descriptions are omitted, the contents described in the first aspect of the present disclosure may be equally applied to the third aspect of the present disclosure.

Regarding the preparation method for the precursor for the synthesis of the Group III-V quantum dots according to the present disclosure, the preparation may be performed by mixing the Group H precursor, the Group V precursor, and the first solvent, which are reactants for preparing the Group I-V cluster compound, at once at a room temperature and heating a resulting mixture as in the method according to the second aspect of the present disclosure, and the preparation may also be performed by heating a solution in which the Group V precursor and the first solvent are mixed and adding the Group I precursor to the heated solution, or by heating a solution in which the Group II precursor and the first solvent are mixed and adding the Group V precursor to the heated solution.

According to one embodiment of the present disclosure, the Group II precursor may be selected from the group consisting of diethyl zinc, zinc oleate, zinc acetate, dimethyl zinc, zinc carboxylate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, dimethyl cadmium, diethyl cadmium, cadmium oxide, cadmium carbonate, cadmium acetate dihydrate, cadmium acetylacetonate, cadmium fluoride, cadmium chloride, cadmium iodide, cadmium bromide, cadmium perchlorate, cadmium phosphide, cadmium nitrate, cadmium sulfate, cadmium carboxylate, mercury iodide, mercury bromide, mercury fluoride, mercury cyanide, mercury nitrate, mercury perchlorate, mercury sulfate, mercury oxide, mercury carbonate, mercury carboxylate, and combinations thereof, but is not limited thereto.

According to one embodiment of the present disclosure, the Group V precursor may be selected from the group consisting of tris(dimethylamino)arsine (DMA₃As), arsenic oxide, arsenic chloride, arsenic sulfate, arsenic bromide, arsenic iodide, tris(trimethylsilyl)arsenide (TMS₃As), arsenic trioxide, arsenic silylamide, alkyl phosphine, tris(trialkylsilyl)phosphine, tris(dialkylsilyl)phosphine, tris(dialkylamino)phosphine, nitric oxide, nitric acid, ammonium nitrate, and combinations thereof, but is not limited thereto.

According to one embodiment of the present disclosure, the first solvent may be selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof, but is not limited thereto.

In addition, a fourth aspect of the present disclosure provides a preparation method for Group III-V quantum dots, the preparation method including: preparing a second mixture solution by mixing a precursor for synthesis of Group III-V quantum dots according to the first aspect of the present disclosure, a Group III precursor, and a second solvent; and heating the second mixture solution.

Regarding the preparation method for the Group I-V quantum dots according to the fourth aspect of the present disclosure, detailed descriptions of parts overlapping the first to third aspects of the present disclosure have been omitted. However, even though the descriptions are omitted, the contents described in the first to third aspects of the present disclosure may be equally applied to the fourth aspect of the present disclosure.

FIG. 3 is a flowchart showing a preparation method for Group I-V quantum dots according to one embodiment of the present disclosure.

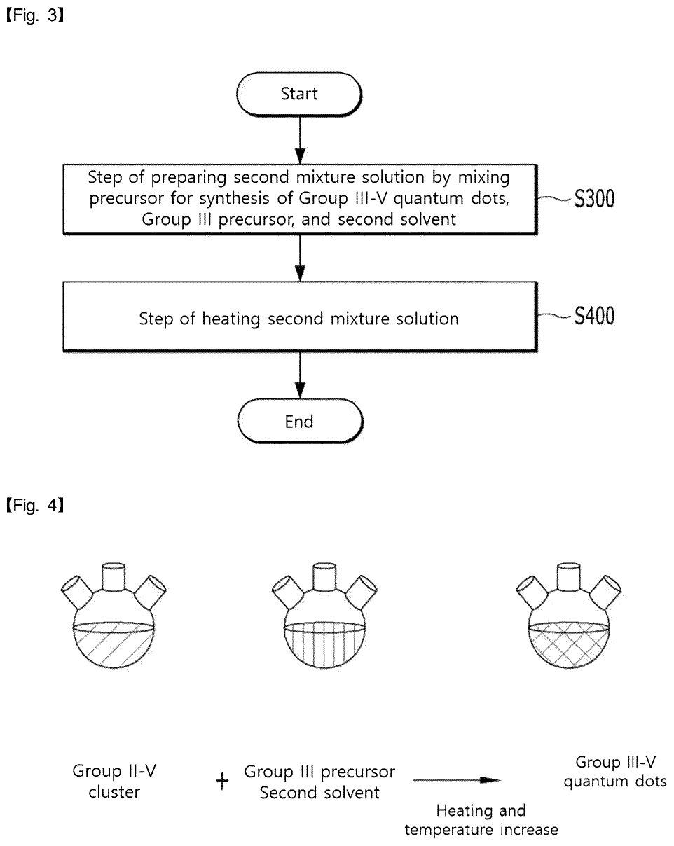

FIG. 4 is a schematic view showing the preparation method for the Group I-V quantum dots according to one embodiment of the present disclosure.

First, a second mixture solution may be prepared by mixing a precursor for synthesis of Group III-V quantum dots according to the first aspect of the present disclosure, a Group III precursor, and a second solvent (S300).

The precursor for the synthesis of the Group III-V quantum dots may include a Group II-V cluster compound, and may be used as a Group V precursor upon the preparation of the Group III-V quantum dots.

According to one embodiment of the present disclosure, the Group III precursor may be selected from the group consisting of indium chloride, indium iodide, indium chloride tetrahydrate, indium oxide, indium nitrate, indium nitrate hydrate, indium sulfate, indium sulfate hydrate, indium acetate, indium acetylacetonate, indium bromide, indium fluoride, indium fluoride trihydrate, trimethyl indium, indium oleate, indium carboxylate, aluminum acetate, aluminum iodide, aluminum bromide, aluminum chloride, aluminum chloride hexahydrate, aluminum fluoride, aluminum nitrate, aluminum oxide, aluminum perchlorate, aluminum carbide, aluminum stearate, aluminum sulfate, di-i-butylaluminum chloride, diethylaluminum chloride, tri-i-butylaluminum, triethylaluminum, triethyl(tri-sec-butoxy)dialuminum, aluminum phosphate, aluminum acetylacetonate, trimethylaluminum, gallium acetylacetonate, gallium chloride, gallium fluoride, gallium fluoride trihydrate, gallium oxide, gallium nitrate, gallium nitrate hydrate, gallium sulfate, gallium iodide, triethyl gallium, trimethyl gallium, and combinations thereof, but is not limited thereto.

According to one embodiment of the present disclosure, the second solvent may be selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof, but is not limited thereto.

Next, the second mixture solution may be heated (S400).

According to one embodiment of the present disclosure, in the heating, a size of the prepared quantum dot may be gradually increased as a heating temperature increases, but is not limited thereto.

According to one embodiment of the present disclosure, in the heating, the heating may be performed while additionally injecting the second mixture solution, but is not limited thereto.

A process of additionally injecting the second mixture solution may be a process that is optionally performed for growth of quantum dots, and the quantum dots may be formed even by the heating without the additional injection.

In addition, a fifth aspect of the present disclosure provides a Group III-V quantum dot prepared by a preparation method according to the fourth aspect of the present disclosure.

Regarding the Group III-V quantum dots according to the fifth aspect of the present disclosure, detailed descriptions of parts overlapping the fourth aspect of the present disclosure have been omitted. However, even though the descriptions are omitted, the contents described in the fourth aspect of the present disclosure may be equally applied to the fifth aspect of the present disclosure.

In addition, a sixth aspect of the present disclosure provides a preparation method for Group II-V quantum dots, the preparation method including: heating a solution including a Group III precursor and a second solvent; and adding a precursor for synthesis of Group III-V quantum dots according to the first aspect of the present disclosure while maintaining a heating temperature of the solution.

Regarding the Group III-V quantum dots according to the sixth aspect of the present disclosure, detailed descriptions of parts overlapping the first to fourth aspects of the present disclosure have been omitted. However, even though the descriptions are omitted, the contents described in the first to fourth aspects of the present disclosure may be equally applied to the sixth aspect of the present disclosure.

Regarding the preparation method for the Group III-V quantum dots according to the present disclosure, the preparation may be performed by mixing the Group III precursor, the second solvent, and the precursor for the synthesis of the Group III-V quantum dots according to the first aspect of the present disclosure, which are reactants for preparing the Group III-V quantum dots, at once and heating a resulting mixture as in the method according to the third aspect of the present disclosure, and the preparation may also be performed by first mixing the Group III precursor and the second solvent, heating a resulting mixture, and adding the precursor for the synthesis of the Group III-V quantum dots according to the first aspect of the present disclosure to the heated solution.

According to one embodiment of the present disclosure, in the heating, a size of the prepared quantum dot may be gradually increased as a heating temperature increases, but is not limited thereto.

According to one embodiment of the present disclosure, the Group III precursor may be selected from the group consisting of indium chloride, indium iodide, indium chloride tetrahydrate, indium oxide, indium nitrate, indium nitrate hydrate, indium sulfate, indium sulfate hydrate, indium acetate, indium acetylacetonate, indium bromide, indium fluoride, indium fluoride trihydrate, trimethyl indium, indium oleate, indium carboxylate, aluminum acetate, aluminum iodide, aluminum bromide, aluminum chloride, aluminum chloride hexahydrate, aluminum fluoride, aluminum nitrate, aluminum oxide, aluminum perchlorate, aluminum carbide, aluminum stearate, aluminum sulfate, di-i-butylaluminum chloride, diethylaluminum chloride, tri-i-butylaluminum, triethylaluminum, triethyl(tri-sec-butoxy)dialuminum, aluminum phosphate, aluminum acetylacetonate, trimethylaluminum, gallium acetylacetonate, gallium chloride, gallium fluoride, gallium fluoride trihydrate, gallium oxide, gallium nitrate, gallium nitrate hydrate, gallium sulfate, gallium iodide, triethyl gallium, trimethyl gallium, and combinations thereof, but is not limited thereto.

According to one embodiment of the present disclosure, the second solvent may be selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof, but is not limited thereto.

According to one embodiment, the preparation method for the Group I-v quantum dots may include: mixing the Group II-V cluster compound, the Group V precursor, and the second solvent; and heating the Group II-V cluster compound, the Group V precursor, and the second solvent, which are mixed.

Alternatively, according to another embodiment, the preparation method for the Group III-V quantum dots may include: mixing and heating the Group II precursor and the second solvent; and adding the Group II-V cluster compound to the Group III precursor and the second solvent, which are mixed and heated.

Alternatively, according to still another embodiment, the preparation method for the Group III-V quantum dots may include: growing a quantum dot seed by additionally injecting at least one of the Group II-V cluster compound, the Group V precursor, or the second solvent in a state in which the quantum dot seed is generated by mixing and heating the Group II-V cluster compound, the Group V precursor, and the second solvent. In detail, the Group III precursor, the Group II-V cluster compound, and the second solvent may be additionally injected in the state in which the quantum dot seed is generated, or the Group V precursor may be additionally injected in the state in which the quantum dot seed is generated.

Alternatively, according to yet another embodiment, the preparation method for the Group III-V quantum dots may include: mixing and heating the Group III precursor and the second solvent; adding the Group II-V cluster compound to the Group III precursor and the second solvent, which are mixed and heated; and growing a quantum dot seed by additionally injecting at least one of the Group II-V cluster compound, the Group V precursor, or the second solvent in a state in which the quantum dot seed is generated by the mixing and heating and the adding. In detail, the Group III precursor, the Group II-V cluster compound, and the second solvent may be additionally injected in the state in which the quantum dot seed is generated, or the Group V precursor may be additionally injected in the state in which the quantum dot seed is generated.

The present disclosure will be described in more detail through the following examples. However, the following examples are only for the purpose of description, and are not intended to limit the scope of the present disclosure.

### [Example 1] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), 1.5 ml of oleylamine, and 1 ml of trioctylphosphine are mixed at 240° C. for 10 minutes. In this case, oleylamine and trioctylphosphine, which are solvents, did not have a significant influence even when added in excessive amounts.

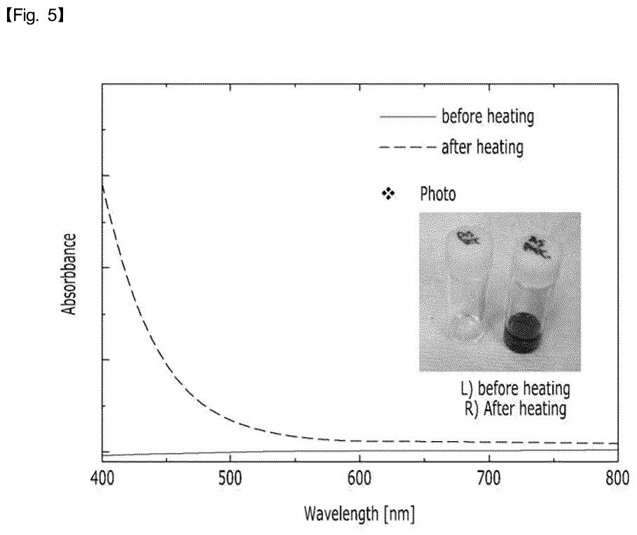

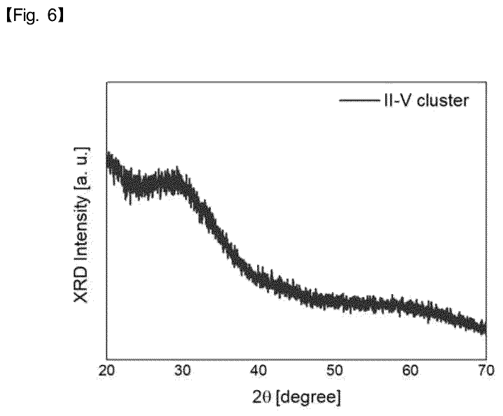

FIG. 5 is an absorbance spectrum and an image showing states before and after heating of a mixture solution for preparing a Group II-V cluster compound according to one example of the present disclosure.

Referring to FIG. 5, it may be found that a color and an absorbance spectrum of the mixture solution are significantly changed due to formation of the cluster after heating the mixture solution.

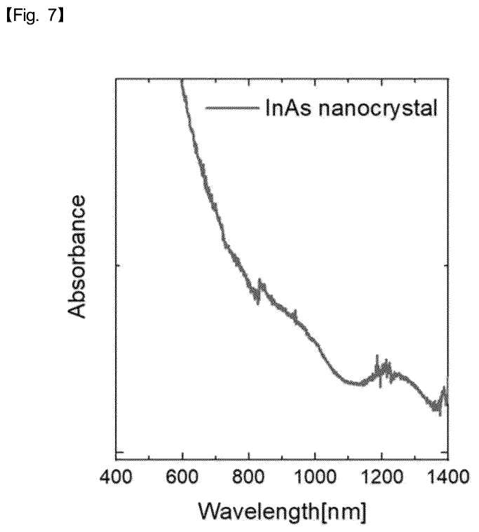

FIG. 6 is an XRD pattern showing the Group II-V cluster compound prepared according to one example of the present disclosure.

Referring to FIG. 6, it may be found that the Zn₃As₂ cluster according to Example 1 has amorphous characteristics.

### [Example 2] Preparation of Zinc Arsenide (Zn₃As₂) Cluster

First, a Zn-oleate solution was synthesized by degassing a solution in which 1.1 g (3 mmol) of zinc oleate (Zn(OAc)₂), 3.34 g (6 mmol) of oleic acid, and 30 mL of octadecene are mixed at 110° C., and a temperature of the Zn-oleate solution was maintained at 100° C.

Next, a solution including TMS₃As was prepared by mixing 0.84 g (1.5 mmol) of TMS₃As, 6 mL of octadecene, and 2.16 g (4.5 mmol) of dioctylamine and heating a resulting mixture at 60° C. for 30 minutes, and a Zn₃As₂ cluster was prepared by injecting the solution including TMS₃As into the Zn-oleate solution and reacting a resulting solution for 10 minutes.

### [Example 3] Preparation of Indium Arsenide Quantum Dots

Indium arsenide quantum dots were prepared by heating a mixture solution in which the zinc arsenide cluster prepared in Example 1, indium(III) chloride, and oleylamine are mixed.

The InAs quantum dots were formed by first mixing the zinc arsenide cluster (0.25 mmol of As) prepared in Example 1 with a solution including 1 mmol of InCl₃ and 12 mL of oleylamine, and heating a resulting mixture in a temperature range of 160° C. to 320° C.

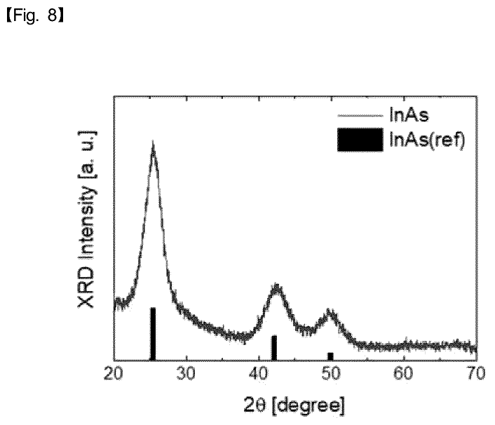

FIG. 7 is an absorbance spectrum showing InAs quantum dots prepared according to one example of the present disclosure.

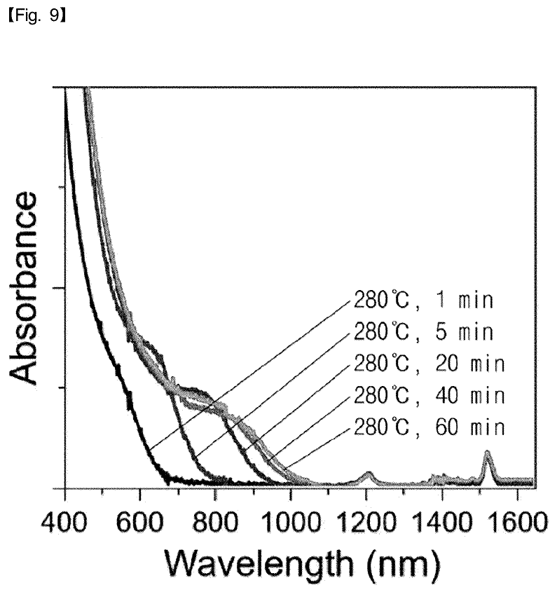

FIG. 8 is an XRD pattern showing the InAs quantum dots prepared according to one example of the present disclosure.

Referring to FIGS. 7 and 8, it may be found that InAs quantum dots having an absorbance of 1200 nm are prepared by using the Group II-V cluster compound (Zn₃As₂) according to Example 1.

### [Example 4] Preparation of Indium Arsenide Quantum Dots

InAs quantum dots were formed by heating a solution including 1 mmol of InCl₃ and 12 mL of oleylamine to a temperature range of 160° C. to 320° C., and injecting the zinc arsenide cluster (0.25 mmol of As) prepared in Example 1. Accordingly, it was found that growth of quantum dots occurred through maintaining the temperature after the heating. (maintaining the temperature for 30 minutes to 1 hour based on 320° C.)

### [Example 5-1] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), 1.5 ml of oleylamine, and 1 ml of trioctylphosphine are mixed at 280° C. for 1 minute.

### [Example 5-2] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), 1.5 ml of oleylamine, and 1 ml of trioctylphosphine are mixed at 280° C. for 5 minutes.

### [Example 5-3] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), 1.5 ml of oleylamine, and 1 ml of trioctylphosphine are mixed at 280° C. for 20 minutes.

### [Example 5-4] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), 1.5 ml of oleylamine, and 1 ml of trioctylphosphine are mixed at 280° C. for 40 minutes.

### [Example 5-5] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), 1.5 ml of oleylamine, and 1 ml of trioctylphosphine are mixed at 280° C. for 60 minutes.

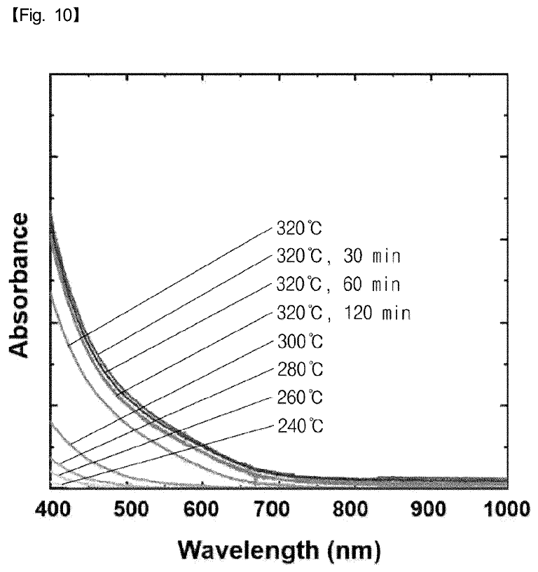

FIG. 9 is an absorbance spectrum showing Group II-V cluster compounds prepared according to Examples 5-1 to 5-5 of the present disclosure.

An absorbance spectrum may be interpreted such that a particle size is gradually increased as an absorbed wavelength becomes longer. Referring to FIG. 9, it may be observed that the absorbed wavelength gradually becomes longer as a heating time increases in synthesis of the Group II-V cluster compounds according to the examples of the present disclosure. Therefore, according to the examples of the present disclosure, it may be proven that a cluster gradually grows as the heating time increases in the synthesis of the Group II-V cluster compounds.

### [Example 6-1] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), and 10 ml of oleylamine are mixed at 100° C. for 10 minutes.

### [Example 6-2] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), and 10 ml of oleylamine are mixed at 220° C. for 10 minutes.

### [Example 6-3] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), and 10 ml of oleylamine are mixed at 240° C. for 10 minutes.

### [Example 6-4] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), and 10 ml of oleylamine are mixed at 260° C. for 10 minutes.

### [Example 6-5] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), and 10 ml of oleylamine are mixed at 280° C. for 10 minutes.

### [Example 6-6] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), and 10 ml of oleylamine are mixed at 300° C. for 10 minutes.

### [Example 6-7] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), and 10 ml of oleylamine are mixed at 320° C. for 10 minutes.

### [Example 6-8] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), and 10 ml of oleylamine are mixed at 320° C. for 30 minutes.

### [Example 6-9] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), and 10 ml of oleylamine are mixed at 320° C. for 60 minutes.

### [Example 6-10] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diethyl zinc (Et₂Zn), and 10 ml of oleylamine are mixed at 320° C. for 120 minutes.

FIG. 10 is an absorbance spectrum showing Group II-V cluster compounds prepared according to Examples 6-1 to 6-10 of the present disclosure.

Referring to Examples 6-1 to 6-7 (100° C. to 320° C., 10 min) of the present disclosure shown in FIG. 10, it may be observed that an absorbed wavelength gradually becomes longer as a heating temperature increases in synthesis of the Group II-V cluster compounds according to the examples of the present disclosure. Therefore, according to the examples of the present disclosure, it may be proven that a cluster gradually grows as the heating temperature increases in the synthesis of the Group I-V cluster compounds.

In addition, referring to Examples 6-7 (320° C., 10 min) to 6-10 (320° C., 120 min) of the present disclosure shown in FIG. 10, it may be observed that the absorbed wavelength is longest when the heating time is 30 minutes in the synthesis of the Group II-V cluster compounds according to the examples of the present disclosure. Therefore, according to the examples of the present disclosure, critical significance may be proven when the heating time is 30 minutes in the synthesis of the Group I-V cluster compounds.

### [Example 7-1] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diisopropylzine, and 10 ml of oleylamine are mixed at 100° C. for 10 minutes.

### [Example 7-2] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diisopropylzinc, and 10 ml of oleylamine are mixed at 220° C. for 10 minutes.

### [Example 7-3] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diisopropylzinc, and 10 ml of oleylamine are mixed at 240° C. for 10 minutes.

### [Example 7-4] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diisopropylzinc, and 10 ml of oleylamine are mixed at 260° C. for 10 minutes.

### [Example 7-5] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diisopropylzinc, and 10 ml of oleylamine are mixed at 280° C. for 10 minutes.

### [Example 7-6] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diisopropylzinc, and 10 ml of oleylamine are mixed at 300° C. for 10 minutes.

### [Example 7-7] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diisopropylzine, and 10 ml of oleylamine are mixed at 320° C. for 10 minutes.

### [Example 7-8] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diisopropylzine, and 10 ml of oleylamine are mixed at 320° C. for 30 minutes.

### [Example 7-9] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diisopropylzinc, and 10 ml of oleylamine are mixed at 320° C. for 60 minutes.

### [Example 7-10] Preparation of Zinc Arsenide (Zn₃As₂) Cluster

A zinc arsenide (Zn₃As₂) cluster was prepared by reacting a mixture solution in which 0.6 mmol of tris(dimethylamino)arsine (DMA₃As), 1.2 mmol of diisopropylzinc, and 10 ml of oleylamine are mixed at 320° C. for 120 minutes.

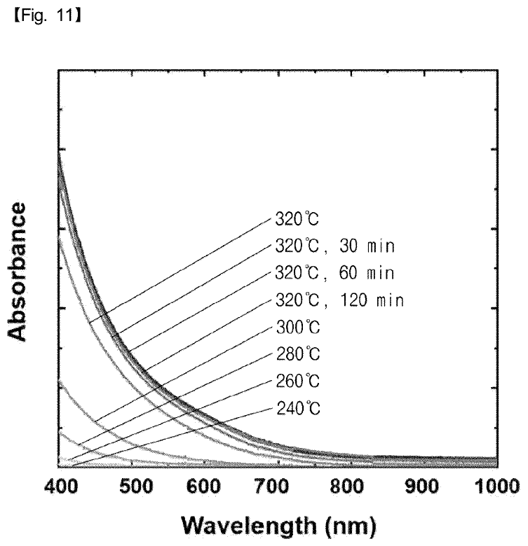

FIG. 11 is an absorbance spectrum showing Group II-V cluster compounds prepared according to Examples 7-1 to 7-10 of the present disclosure.

Referring to Examples 7-1 to 7-7 (100° C. to 320° C., 10 min) of the present disclosure shown in FIG. 11, it may be observed that an absorbed wavelength gradually becomes longer as a heating temperature increases in synthesis of the Group II-V cluster compounds according to the examples of the present disclosure. Therefore, according to the examples of the present disclosure, it may be proven that a cluster gradually grows as the heating temperature increases in the synthesis of the Group I-V cluster compounds.

In addition, referring to Examples 7-7 (320° C., 10 min) to 7-10 (320° C., 120 min) of the present disclosure shown in FIG. 11, it may be observed that the absorbed wavelength is longest when the heating time is 60 minutes in the synthesis of the Group II-V cluster compounds according to the examples of the present disclosure. Therefore, according to the examples of the present disclosure, critical significance may be proven when the heating time is 60 minutes in the synthesis of the Group I-V cluster compounds.

The above description of the present disclosure is for illustrative purposes only, and it will be understood by a person having skill in the art to which the present disclosure pertains that the present disclosure can be easily modified in other specific forms without changing the technical idea or essential characteristics of the present disclosure. Therefore, the embodiments described above are illustrative in all aspects, and are not to be construed as limiting. For example, each component described in a single form may be implemented in a distributed manner, and similarly, components described as being distributed may be implemented in a combined form.

The scope of the present disclosure is defined by the claims described below rather than the detailed description, and the scope of the present disclosure is to be interpreted as encompassing all changes or modifications derived from the meaning and scope of the claims and equivalent concepts thereof.

1. A precursor for synthesis of Group III-V quantum dots, the precursor comprising:
a Group II-V cluster compound having amorphous characteristics.

2. The precursor of claim 1, wherein a Group II element of the Group II-V cluster compound is selected from the group consisting of Zn, Cd, Hg, and combinations thereof,
a Group V element of the Group II-V cluster compound is selected from the group consisting of As, N, P, Sb and combinations thereof, and
the Group II-V cluster compound includes a composition of Zn₃As₂, Zn₃As, Cd₃As₂, or Cd₃P₂.

3. The precursor of claim 1, wherein the Group II-V cluster compound is stored at a room temperature or less.

4. The precursor of claim 1, wherein the Group III-V quantum dot is selected from the group consisting of InAs, InP, In₁₋ₓGaₓP_{1-y}As_{y} (where each of x and y is greater than 0 and less than 1), In₁₋ₓZnₓP_{1-y}As_{y} (where each of x and y is greater than 0 and less than 1), In₁₋ₓCdₓP_{1-y}As_{y} (where each of x and y is greater than 0 and less than 1), and combinations thereof.

5. A preparation method for a precursor for synthesis of Group III-V quantum dots, the preparation method comprising:
preparing a first mixture solution by mixing a Group II precursor, a Group V precursor, and a first solvent; and
preparing a Group II-V cluster compound by heating the first mixture solution.

6. The preparation method of claim 5, wherein, in the preparing of the Group II-V cluster compound, formation of the Group II-V cluster compound is adjusted by controlling a heating temperature and/or a heating time.

7. The preparation method of claim 5, wherein the Group II precursor is selected from the group consisting of diethyl zinc, zinc oleate, zinc acetate, dimethyl zinc, zinc carboxylate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, dimethyl cadmium, diethyl cadmium, cadmium oxide, cadmium carbonate, cadmium acetate dihydrate, cadmium acetylacetonate, cadmium fluoride, cadmium chloride, cadmium iodide, cadmium bromide, cadmium perchlorate, cadmium phosphide, cadmium nitrate, cadmium sulfate, cadmium carboxylate, mercury iodide, mercury bromide, mercury fluoride, mercury cyanide, mercury nitrate, mercury perchlorate, mercury sulfate, mercury oxide, mercury carbonate, mercury carboxylate, and combinations thereof,
the Group V precursor is selected from the group consisting of tris(dimethylamino)arsine (DMA₃As), arsenic oxide, arsenic chloride, arsenic sulfate, arsenic bromide, arsenic iodide, tris(trimethylsilyl)arsenide (TMS₃As), arsenic trioxide, arsenic silylamide, alkyl phosphine, tris(trialkylsilyl)phosphine, tris(dialkylsilyl)phosphine, tris(dialkylamino)phosphine, nitric oxide, nitric acid, ammonium nitrate, and combinations thereof, and
the first solvent is selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof.

8. A preparation method for a precursor for synthesis of Group III-V quantum dots, the preparation method comprising:
heating a solution in which a first precursor and a first solvent are mixed; and
preparing a Group II-V cluster compound by adding a second precursor while maintaining a heating temperature of the solution,
wherein the first precursor and the second precursor are each independently a Group II precursor or a Group V precursor, and
the first precursor and the second precursor are different from each other.

9. The preparation method of claim 8, wherein the Group II precursor is selected from the group consisting of diethyl zinc, zinc oleate, zinc acetate, dimethyl zinc, zinc carboxylate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, dimethyl cadmium, diethyl cadmium, cadmium oxide, cadmium carbonate, cadmium acetate dihydrate, cadmium acetylacetonate, cadmium fluoride, cadmium chloride, cadmium iodide, cadmium bromide, cadmium perchlorate, cadmium phosphide, cadmium nitrate, cadmium sulfate, cadmium carboxylate, mercury iodide, mercury bromide, mercury fluoride, mercury cyanide, mercury nitrate, mercury perchlorate, mercury sulfate, mercury oxide, mercury carbonate, mercury carboxylate, and combinations thereof,
the Group V precursor is selected from the group consisting of tris(dimethylamino)arsine (DMA₃As), arsenic oxide, arsenic chloride, arsenic sulfate, arsenic bromide, arsenic iodide, tris(trimethylsilyl)arsenide (TMS₃As), arsenic trioxide, arsenic silylamide, alkyl phosphine, tris(trialkylsilyl)phosphine, tris(dialkylsilyl)phosphine, tris(dialkylamino)phosphine, nitric oxide, nitric acid, ammonium nitrate, and combinations thereof, and
the first solvent is selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof.

10. A preparation method for Group III-V quantum dots, the preparation method comprising:
preparing a second mixture solution by mixing a precursor for synthesis of Group III-V quantum dots according to one of claim 1, a Group III precursor, and a second solvent; and
heating the second mixture solution.

11. The preparation method of claim 10, wherein, in the heating, a size of the prepared quantum dot is gradually increased as a heating temperature increases.

12. The preparation method of claim 10, wherein, in the heating, the heating is performed while additionally injecting the second mixture solution.

13. The preparation method of claim 10, wherein the Group III precursor is selected from the group consisting of indium chloride, indium iodide, indium chloride tetrahydrate, indium oxide, indium nitrate, indium nitrate hydrate, indium sulfate, indium sulfate hydrate, indium acetate, indium acetylacetonate, indium bromide, indium fluoride, indium fluoride trihydrate, trimethyl indium, indium oleate, indium carboxylate, aluminum acetate, aluminum iodide, aluminum bromide, aluminum chloride, aluminum chloride hexahydrate, aluminum fluoride, aluminum nitrate, aluminum oxide, aluminum perchlorate, aluminum carbide, aluminum stearate, aluminum sulfate, di-i-butylaluminum chloride, diethylaluminum chloride, tri-i-butylaluminum, triethylaluminum, triethyl(tri-sec-butoxy)dialuminum, aluminum phosphate, aluminum acetylacetonate, trimethylaluminum, gallium acetylacetonate, gallium chloride, gallium fluoride, gallium fluoride trihydrate, gallium oxide, gallium nitrate, gallium nitrate hydrate, gallium sulfate, gallium iodide, triethyl gallium, trimethyl gallium, and combinations thereof, and
the second solvent is selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof.

14. A Group III-V quantum dot prepared by a preparation method according to one of claim 10.

15. A preparation method for Group III-V quantum dots, the preparation method comprising:
heating a solution including a Group III precursor and a second solvent; and
adding a precursor for synthesis of Group III-V quantum dots according to one of claim 1 while maintaining a heating temperature of the solution.

16. The preparation method of claim 15, wherein, in the heating, a size of the prepared quantum dot is gradually increased as a heating temperature increases.

17. The preparation method of claim 15, wherein the Group III precursor is selected from the group consisting of indium chloride, indium iodide, indium chloride tetrahydrate, indium oxide, indium nitrate, indium nitrate hydrate, indium sulfate, indium sulfate hydrate, indium acetate, indium acetylacetonate, indium bromide, indium fluoride, indium fluoride trihydrate, trimethyl indium, indium oleate, indium carboxylate, aluminum acetate, aluminum iodide, aluminum bromide, aluminum chloride, aluminum chloride hexahydrate, aluminum fluoride, aluminum nitrate, aluminum oxide, aluminum perchlorate, aluminum carbide, aluminum stearate, aluminum sulfate, di-i-butylaluminum chloride, diethylaluminum chloride, tri-i-butylaluminum, triethylaluminum, triethyl(tri-sec-butoxy)dialuminum, aluminum phosphate, aluminum acetylacetonate, trimethylaluminum, gallium acetylacetonate, gallium chloride, gallium fluoride, gallium fluoride trihydrate, gallium oxide, gallium nitrate, gallium nitrate hydrate, gallium sulfate, gallium iodide, triethyl gallium, trimethyl gallium, and combinations thereof, and
the second solvent is selected from the group consisting of oleylamine, trioctylphosphine, butylamine, octylamine, dioctylamine, oleic acid, octadecene, dodecylamine, hexadecylamine, hexylamine, propylamine, aniline, benzylamine, octadecylamine, hexadecene, and combinations thereof.

18. (canceled)

19. (canceled)

20. (canceled)
